(19) United States
(12) Patent Application Publication
(10) Pub. No.: US 2012/0320606 A1
(43) Pub. Date: Dec. 20, 2012

(54) ENVELOPE-CONFIGURED LAMP SHADE

(75) Inventor: Sohrab Vossoughi, Portland, OR (US)

(73) Assignee: Aria Enterprises, Inc., Portland, OR (US)

(21) Appl. No.: 13/160,097

(22) Filed: Jun. 14, 2011

(51) Int. Cl. F21V 1/00; F21V 1/20; F21V 1/22

(52) U.S. Cl. 362/351

(57) ABSTRACT

A lamp shade envelops and holds a lamp assembly that includes a light bulb having an enclosure portion and a connector portion connected to a lamp socket. The lamp shade includes two sheets joined at opposite side margins to form an envelope with separable top and bottom side margins. Each sheet is characterized by a rigidity property exhibiting an elastic restorative force that urges together the separable top and the bottom side margins in the absence of a lamp assembly positioned between the sheets. Spatially aligned openings in the sheets form a two-sided lamp shade aperture from which sections of the enclosure portion protrude when the lamp assembly is positioned within an interior space between the joined sheets. The sheets bend around the enclosure portion to expand the envelope to a convex shape, and the elastic restorative force holds the enclosure portion in place within the interior space.

### COPYRIGHT NOTICE

©2011 Aria Enterprises, Inc. A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### TECHNICAL FIELD

This disclosure relates to lamp shades and, in particular, to a lamp shade made of multiple sheets joined to envelop a lamp assembly and provided with a two-sided aperture through which sections of opposite surfaces of the glass enclosure portion of the lamp assembly protrude to hold it in place within the envelope.

### BACKGROUND INFORMATION

Conventional lamp shades are typically made of metal or cloth in cylindroid shapes and are configured with mounting hardware to conceal a light bulb without completely covering or contacting it. Concealing the light bulb is often accomplished by insertion of the free ends of a metal harp into a harp bottom mounted on a lamp base. A lamp shade having a spider provided with a center hole receives a mounting post located at the apex of the harp and, with use of a mounting screw, is secured to the harp and thereby to the lamp base to encompass the light bulb without touching it.

Lamp covers, such as a lamp cover of a type described in U.S. Patent Application Pub. No. 2008/0030138, fully enclose but do not hold a lamp assembly within an interior region of the lamp cover.

### SUMMARY OF THE DISCLOSURE

A lamp shade envelops and holds a lamp assembly that includes a light bulb having an enclosure portion and a connector portion connected to a lamp socket. The lamp shade includes first and second sheets joined at opposite side margins to form an envelope with separable top and bottom side margins. Each of the first and second sheets is characterized by a rigidity property exhibiting an elastic restorative force that urges together the top and the bottom side margins of the joined first and second sheets in the absence of a lamp assembly positioned between them. First and second spatially aligned openings in the respective first and second sheets form a two-sided lamp shade aperture from which sections of the enclosure portion protrude when the lamp assembly is positioned within an interior space between and is enveloped by the joined first and second sheets. The two-sided lamp aperture has an aperture size that contributes to sizes of the protruding sections and encompasses the enclosure portion with the result that the first and second sheets bend around the enclosure portion to expand the envelope to a convex shape and the elastic restorative force holds the enclosure portion in place within the interior space. The first and second sheets have exterior surfaces on which user-customized decorative artistic patterns can be placed.

Additional aspects and advantages will be apparent from the following detailed description of preferred embodiments, which proceeds with reference to the accompanying drawings.

### BRIEF DESCRIPTION OF THE DRAWINGS

FIGS. 1A, 1B, and 1C show isometric views of a first embodiment of an envelope-configured lamp shade in, respectively, relaxed, partly open, and light bulb holding operational states.

FIGS. 2A, 2B, and 2C are top plan views of the lamp shade shown in the corresponding operational states depicted in FIGS. 1A, 1B, and 1C, respectively.

FIG. 3 is a top plan view of an alternative embodiment of flat sheets used in the construction of the lamp shade of FIG. 1A, in which each of them is formed from multiple bonded layers and thereby afford decorative design flexibility.

FIG. 4 is an isometric view of the lamp shade of FIG. 1B holding a lamp assembly and having, at the corners of the bottom side margins of the lamp shade, angled tabs that form two two-prong feet to enable the lamp shade to stand upright on a horizontal support surface.

FIGS. 5A and 5B are, respectively, isometric and top plan views of the lamp shade of FIG. 1B holding a lamp assembly and provided with four notches in the bottom side margins of the lamp shade to receive a support ring forming a laterally extended curved table mount.

FIGS. 6A and 6B are, respectively, isometric and top plan views of the lamp shade of FIG. 1B holding a lamp assembly and provided with two notches in the bottom side margins of the lamp shade to receive a flat stick forming a laterally extending straight table mount.

FIG. 7 is an isometric view of the lamp shade of FIG. 1B suspended from a ceiling mount by a power cord of the lamp assembly held by the lamp shade.

FIG. 8 is an isometric view of the lamp shade of FIG. 1B mounted on a pedestal that includes a circular base from which a rod upwardly extends and connects at its free end to a socket of the light assembly held by the lamp shade.

FIG. 9 shows, as a second embodiment, an isometric view of the lamp shade of FIG. 1B constructed with two two-sided apertures to hold two vertically stacked light assemblies.

FIG. 10 show, as a third embodiment, an isometric view of the lamp shade of FIG. 1B constructed with an elongated aperture that is sized to hold a tubular enclosure portion of a tubular light bulb.

### DETAILED DESCRIPTION OF PREFERRED EMBODIMENTS

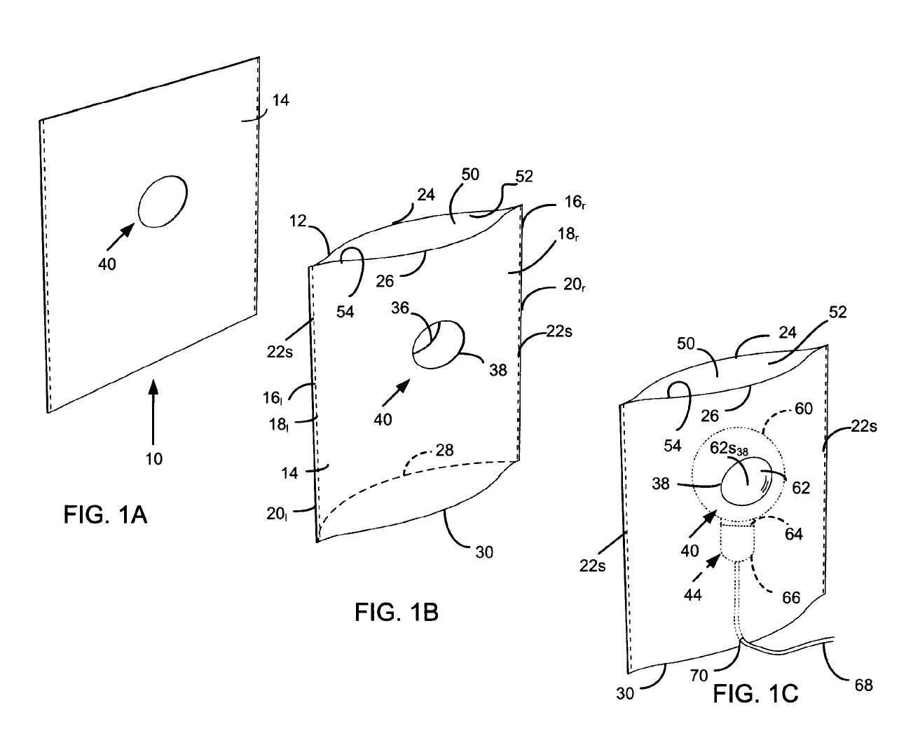

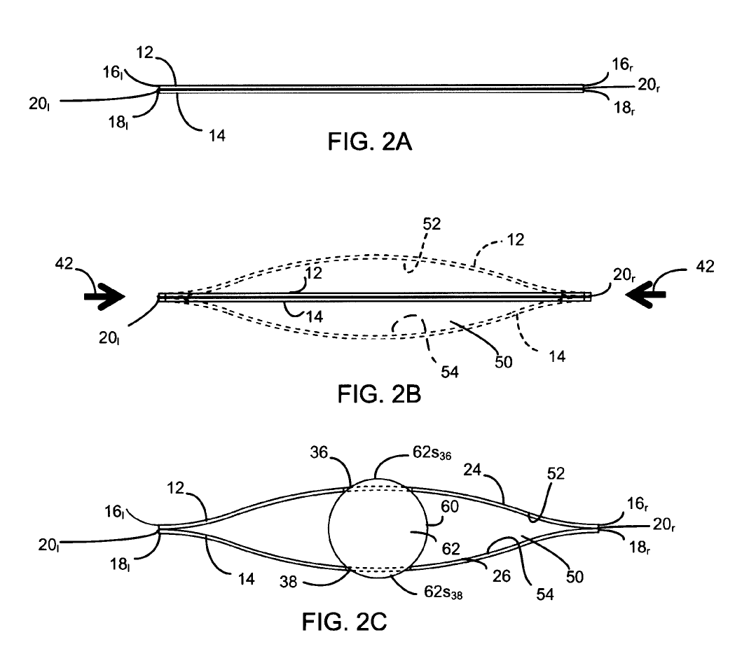

FIGS. 1A, 1B, and 1C show, as a first embodiment for use with a single spherical light bulb-containing lamp assembly, isometric views of an envelope-configured lamp shade in, respectively, relaxed, partly open, and light bulb-holding operational states. FIGS. 2A, 2B, and 2C are top plan views of the lamp shade shown in the corresponding operational states depicted in FIGS. 1A, 1B, and 1C, respectively.

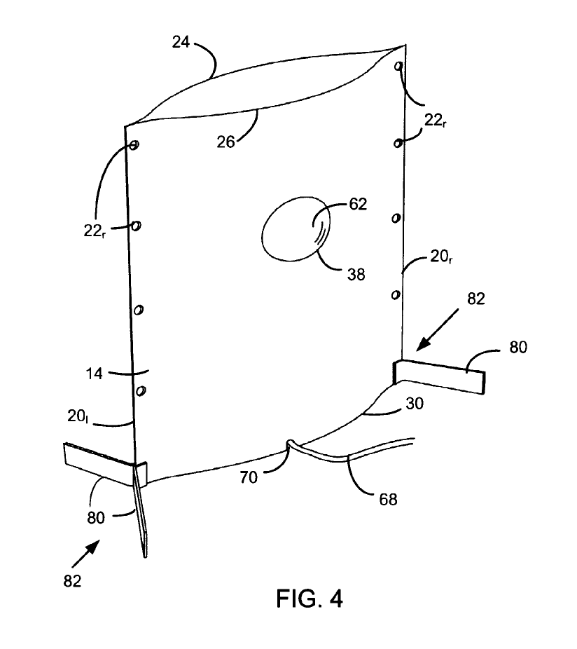

With reference to FIGS. 1A, 1B, 1C, 2A, 2B, and 2C, an envelope-configured lamp shade 10 includes a first rectangular flat sheet 12 and a second rectangular flat sheet 14 joined at their respective left side margins 16ₗ and 18ₗ to form an envelope left side margin 20ₗ and at their respective right side margins 16ᵣ and 18ᵣ to form an envelope right side margin 20ᵣ. Left side margins 16ₗ and 18ₗ and right side margins 16ᵣ and 18ᵣ may be joined by any suitable bonding technique or fasteners such as rivets 22r (FIG. 4) or sewn seams 22s (FIGS. 1A, 1B, and 1C). Sheets 12 and 14 have respective non-joined top side margins 24 and 26 and respective non-joined bottom side margins 28 and 30 that form openable top and bottom sides for lamp shade 10. Sheets 12 and 14 have respective spatially aligned openings 36 and 38 that form for lamp shade 10 a two-sided lamp shade aperture 40.

Sheets 12 and 14 are made of material that is characterized by a rigidity property exhibiting an elastic restorative force that urges top side margins 24 and 26 together and bottom side margins 28 and 30 together to a relaxed operational state (FIGS. 1A and 2A) when no inwardly directed force 42 (FIG. 2B) is applied to envelope side margins 20ₗ and 20ᵣ or no lamp assembly 44 (FIG. 1C) is positioned between sheets 12 and 14. Inwardly directed force 42 of sufficient magnitude applied to envelope side margins 20ₗ and 20ᵣ spreads apart and thereby opens a space 50 between interior surfaces 52 and 54 of the respective sheets 12 and 14 and causes them to bow outwardly in a partly open state to provide lamp shade 10 with a convex shape (FIG. 1B and FIG. 2B (phantom lines)).

Lamp assembly 44 includes a light bulb 60 that has a spherical glass enclosure portion 62 and a connector portion 64. In the embodiments shown, glass enclosure portion 62 is of spherical shape but can be of any uniform shape. Light bulb 60 is of a low-heat emitting type because lamp shade 10 is in direct contact with glass enclosure portion 62. High-heat emitting bulbs may cause melting, discoloration, or burning of certain materials of which sheets 12 and 14 are made. Preferred low-heat emitting bulbs include low voltage (decorative) incandescent, compact fluorescent, or light-emitting diode bulbs.

A light bulb socket 66 receives connector portion 64 of light bulb 60 and 120 VAC power cord 68. Lamp assembly 44 can be inserted into space 50 of lamp shade 10 through either its top side or bottom side and positioned to seat glass enclosure portion 62 in openings 36 and 38 of the respective sheets 12 and 14. Opposite side surface sections 62s₃₆ and 62s₃₈ of enclosure portion 62 protrude through the respective openings 36 and 38 of two-sided lamp shade aperture 40, as shown in FIGS. 1C and 2C. The sizes of side surface sections 62s₃₆ and 62s₃₈ are established by the shape of enclosure portion 62 and the sizes of openings 36 and 38 in the respective sheets 12 and 14. Sheets 12 and 14 bend around glass enclosure portion 62 to expand the envelope to a convex shape, and the elastic restorative force of joined sheets 12 and 14 holds enclosure portion 62 in place to assume a light bulb-holding operational state. A notch 70 cut into bottom side margin 30 provides an exit port for power cord 68 and thereby allows lamp shade 10 to operate as a freestanding lamp assembly holder.

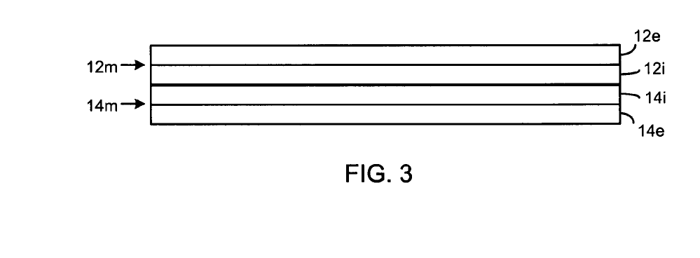

FIG. 3 is a top plan view of an alternative embodiment of sheets 12 and 14, in which each of them is formed from multiple bonded layers and thereby afford decorative design flexibility. In the alternative embodiment, sheet 12m is formed from an interior layer 12i bonded to an exterior layer 12e, and sheet 14m is formed from an interior layer 14i bonded to an exterior layer 14e.

The purpose of interior layers 12i and 14i of the respective first and second sheets 12 and 14 is to diffuse light evenly and provide a safe contact point to low-heat light bulbs. Interior layers 12i and 14i are made of material exhibiting light diffusion, semi-stiffness, and heat resistance properties. Interior layers 12i and 14i are translucent so that light emitted from light bulb 60 transmits through sheets 12 and 14 in a substantially even diffused glow while connector portion 64 and light bulb socket 66 remain invisible to observers viewing exterior layers 12e and 14e of lamp shade 10. The semi-stiffness properties provide the interior layer material with sufficient flexibility to bend around the enclosure portion and sufficient stiffness to maintain the convex shape and hold the weight of lamp assembly 44. The interior layer material includes one of styrene plastic (preferably with pressure-sensitive adhesive applied to the surfaces confronting exterior layers 12e and 14e), fiberglass (preferably vinyl coated), Duratrans™ (typically polyethylene terephthalete (PET)) sheet, or any other material providing the above-noted properties. Interior layers 12i and 14i exhibit low flammability and heat resistance properties. Low flammability (certified or tested by Underwriters Laboratories Inc. (UL)) protects against one or both of fire caused by extremely prolonged use and sparking caused by faulty electrical wiring, and heat resistance prevents melting or discoloration after prolonged contact with low-wattage incandescent light bulbs (15-25 W) or compact fluorescent light bulbs (10-20 W). A preferred thickness range of interior layers 12i and 14i is between about 0.4 mm and about 1.25 mm.

The purpose of exterior layers 12e and 14e is to provide a aesthetic patterns, graphics, color, or texture on the exterior surfaces. Exterior layers 12e and 14e are made of material exhibiting light diffusion properties and decoration suitability. Exterior sheets 12e and 14e are made of translucent material that allows transmission of diffused light and have outer surfaces that add color, texture, decorative patterning, or increased light diffusion. Exterior layers 12e and 14e are thin, within a thickness range of about 0.07 mm and about 0.1 mm.

Layers 12i and 12e of sheet 12m and layers 14i and 14e of sheet 14m can be joined in any one of several ways. An adhesive material certified for low flammability may be applied to the confronting surfaces of layers 12i and 12e and the confronting surfaces of layers 14i and 14e. A pressure-sensitive adhesive material would normally be applied to the exterior sheet-confronting surfaces of layers 12i and 14i. A thermo-set adhesive material could also be used. Depending on the type of material, heat welding may be used to join the layers of sheets 12m and 14m. Exterior layers 12e and 14e are made of decorative translucent material and include one of graphic-printed vellum; synthetic papers; wood veneer certified for lighting; polyethylene (PE) foam sheet; rigidized textiles; colored, translucent PET film; bark-cloth; muslin; silk; or any other material providing the above-noted properties.

FIGS. 1A, 1B, and 1C; 2A, 2B, and 2C; and 3 illustrate lamp shade 10 as a freestanding embodiment in which the lamp shade itself constitutes a lamp assembly support structure that rests on a horizontal support surface without ancillary stabilization. The following FIGS. 4, 5A and 5B, 6A and 6B, 7, and 8 illustrate different accessories for use in stable operational placement of lamp shade 10.

FIG. 4 is an isometric view of lampshade 10 holding lamp assembly 44 (only enclosure portion 62 shown) and having at the corners of bottom side margins 28 and 30 pairs of angled tabs 80 separated by an obtuse angle to form two two-prong feet 82 for lampshade 10 so that it can stand upright on a table or other horizontal support surface (not shown).

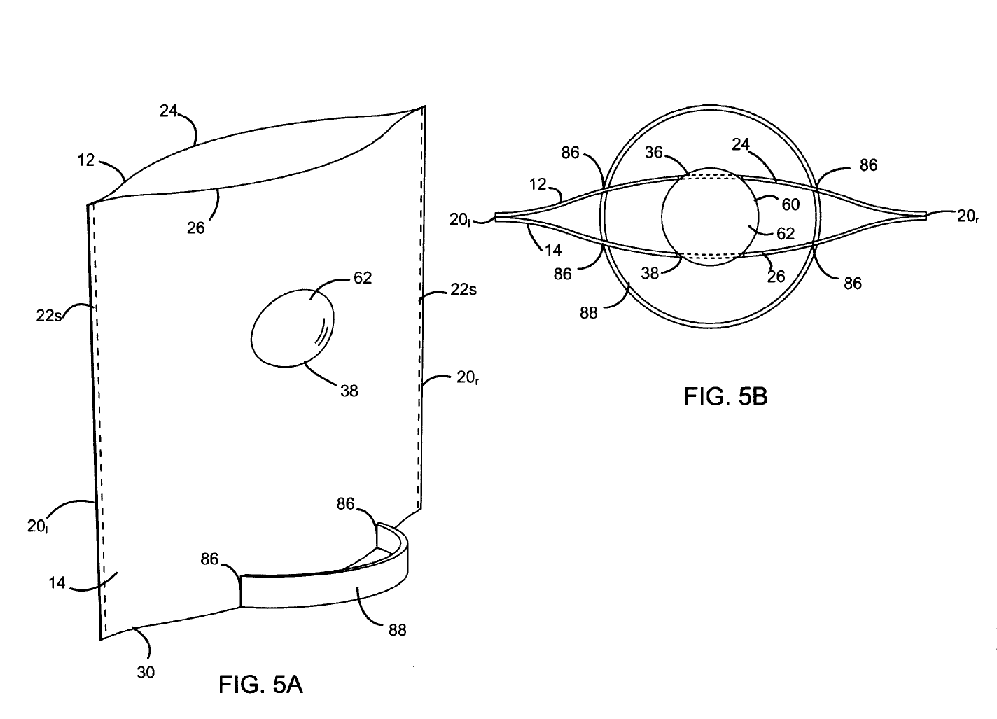

FIGS. 5A and 5B are, respectively, isometric and top plan views of lampshade 10 holding lamp assembly 44 (only enclosure portion 62 of light bulb 60 shown) and provided with four notches 86 in bottom side margins 28 and 30 to receive a support ring 88 forming a laterally extending curved table mount for lampshade 10.

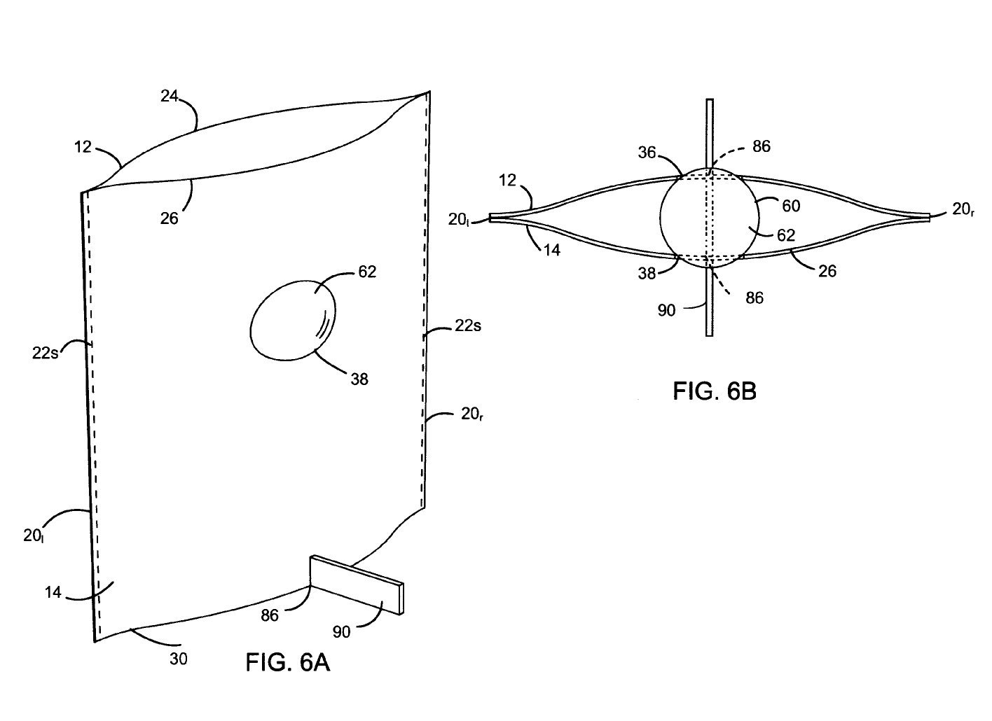

FIGS. 6A and 6B are, respectively, isometric and top plan views of lampshade 10 holding lamp assembly 44 (only enclosure portion 62 of light bulb 60 shown) and provided with two notches 86 in bottom side margins 28 and 30 to receive a flat stick 90 forming a laterally extending straight table mount for lampshade 10.

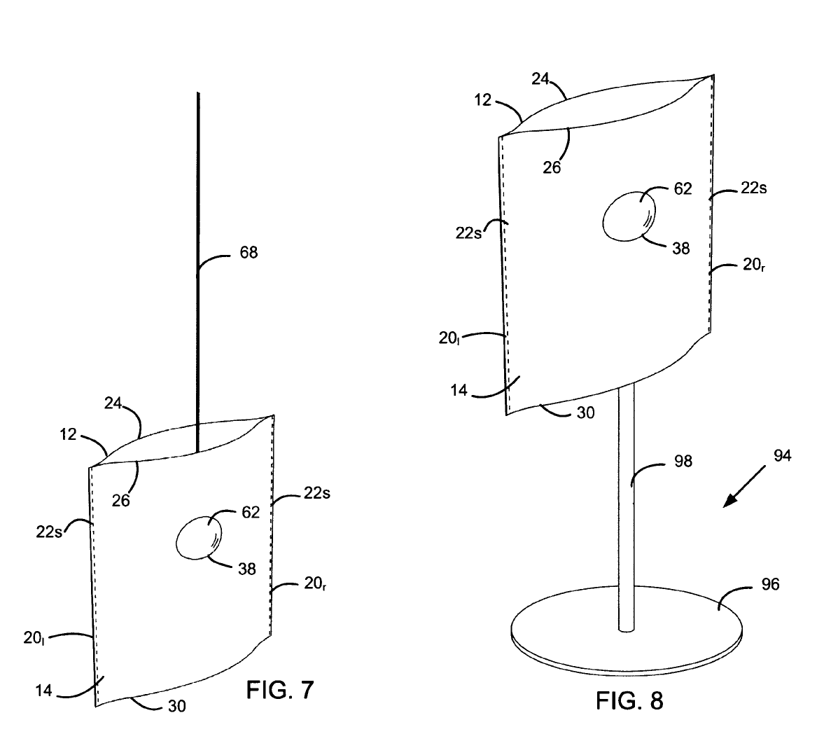

FIG. 7 is an isometric view of lampshade 10 suspended from a ceiling mount (not shown) by power cord 68 of lamp assembly 44 (only enclosure portion 62 shown) held by lampshade 10.

FIG. 8 is an isometric view of lampshade 10 mounted on a pedestal 94 including a circular base 96 from which a rod 98 upwardly extends and connects at its free end to socket 66 (FIG. 1C). Pedestal 94 provides a table or floor mount support for lampshade 10 when it holds lamp assembly 44 (only enclosure portion 62 shown).

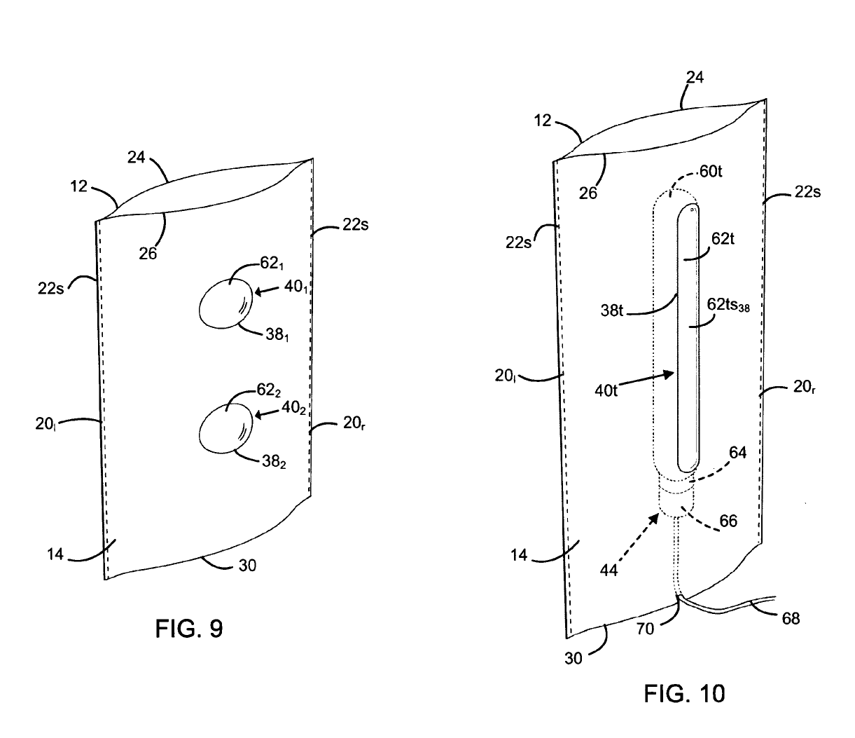

FIG. 9 shows, as a second embodiment for use with two vertically stacked lamp assemblies 44₁ and 44₂ (only the respective enclosure portions 62₁ and 62₂ shown), an isometric view of envelope-configured lamp shade 10 constructed with two two-sided apertures 40₁ and 40₂ (only the respective openings 38₁ and 38₂ shown). This second embodiment is otherwise constructed in the same manner as the first embodiment and its various mounting implementations are constructed.

FIG. 10 shows, as a third embodiment for use with a lamp assembly 44 into which a tubular light bulb 60t is connected, an isometric view of envelope-configured lamp shade 10 constructed with an elongated aperture 40t (only opening 38t in sheet 14 shown) that is sized to hold a tubular enclosure portion 62t (shown in dashed lines except for side surface section 62ts₃₈) of light bulb 60t. This third embodiment is otherwise constructed in the same manner as the first embodiment and its various mounting implementations are constructed.

The following are three examples of numerous possible embodiments of light shade 10.

### Example 1

### Single-Layer Sheet

Two sheets of 0.8 mm-thick resin-impregnated fiberglass, such as Synskin or FRP fiberglass, are fastened together at the two side margins by minimal sewn stitching (straight-line, white thread). The random glass fiber pattern creates a pleasing aesthetic pattern similar to that of Asian ‘Shoji’ screens and lanterns, while the milky white sheets allow transmission of some amount of light through them and give an overall even diffusion of light. The resin or adhesive used to impregnate/bind/stiffen the fiberglass sheets is certified flame-resistant. The stiffness of the sheets can be controlled by the type and amount of binding resin used.

### Example 2

### Two-Layer Sheet with Wood Veneer Exterior

Two thin (interior layer) sheets of 0.4-mm thick polystyrene with pressure-sensitive adhesive are pressed and adhered to different ones of separate (exterior layer) sheets of ultra-thin (0.5 mm) wood veneer. The two two-layer sheets are then fastened together at the two side margins with six rivets on each side. The wood veneer gives an aesthetically pleasing texture and diffused light pattern through the variation in wood grain. The polystyrene layer of each two-layer sheet helps increase stiffness, diffuse light, and provide a bulb-contact surface other than the wood. The inside surface of the wood veneer may need to be covered with a flame-resistant coating to pass UL testing.

### Example 3

### Two-Layer Sheet with Patterned Exterior

Two (interior layer) sheets of 0.8-mm thick polystyrene with pressure-sensitive adhesive are pressed and adhered to the backs of different ones of separate (exterior layer) sheets of vellum paper. The vellum paper has graphic prints applied to the exterior surfaces through a printing process. The two two-layer sheets are then fastened together at the two side margins with decorative sewn stitching (zig-zag or x's in colored thread) on each side. The graphic print on vellum provides an aesthetically pleasing pattern and color variation but continues to allow transmission of diffused light through the lamp shade. The polystyrene layer provides all the stiffness and diffuses the light.

It will be obvious to those having skill in the art that many changes may be made to the details of the above-described embodiments without departing from the underlying principles of the invention. The scope of the present invention should, therefore, be determined only by the following claims.

1. A lamp shade configured to envelop and hold a lamp assembly that includes a light bulb having an enclosure portion and a connector portion connected to a lamp socket, comprising:
first and second sheets joined at opposite side margins to form an envelope with separable top and bottom side margins, each of the first and second sheets characterized by a rigidity property exhibiting an elastic restorative force that urges together the top and the bottom side margins of the joined first and second sheets in the absence of a lamp assembly positioned between them; and
first and second spatially aligned openings in the respective first and second sheets forming a two-sided lamp shade aperture from which sections of the enclosure portion protrude when the lamp assembly is positioned within an interior space between and is enveloped by the joined first and second sheets, the two-sided lamp aperture having an aperture size that contributes to sizes of the protruding sections and encompasses the enclosure portion with the result that the first and second sheets bend around the enclosure portion to expand the envelope to a convex shape and the elastic restorative force holds the enclosure portion in place within the interior space.

2. The lamp shade of claim 1, in which each of the first and second sheets has an exterior surface that is adapted for decorative patterning.

3. The lamp shade of claim 1, in which the lamp assembly has a weight and in which each of the first and second sheets is formed in multiple bonded layers including an interior layer and an exterior layer, the interior layers of the first and second sheets made of material exhibiting heat resistance, semi-stiffness, and light diffusion properties, the semi-stiffness properties providing the interior layer material with sufficient flexibility to bend around the enclosure portion and sufficient stiffness to maintain the convex shape and hold the weight of the lamp assembly, and the light diffusion properties providing the material with translucence so that light emitted from the light bulb transmits in a substantially even diffused glow through the first and second sheets while the connector portion and the lamp socket remain invisible to observers viewing the exterior layers of the lamp shade.

4. The lamp shade of claim 3, in which the exterior layers of the first and second sheets are made of decorative translucent material.

5. The lamp shade of claim 3, in which the interior layer material includes one of styrene plastic, fiberglass, or PET.

6. The lamp shade of claim 3, in which the interior layer material includes one of graphic-printed vellum, synthetic paper, wood veneer, PE foam sheet, rigidized textiles, PET film, bark-cloth, muslin, or silk.

7. The lamp shade of claim 1, in which the first and second sheets are joined by rivets.

8. The lamp shade of claim 1, in which the first and second sheets are joined by sewn seams.
